(19) United States
(12) Patent Application Publication
(10) Pub. No.: US 2025/0287302 A1
(43) Pub. Date: Sep. 11, 2025

(54) Network Power Saving Mode

(71) Applicant: Apple Inc., CUPERTINO, CA (US)

(72) Inventors: Hong HE, San Jose, CA (US); Chunxuan YE, San Diego, CA (US); Dawei ZHANG, Saratoga, CA (US); Haitong SUN, Saratoga, CA (US); Jie CUI, San Jose, CA (US); Seyed Ali Akbar FAKOORIAN, San Diego, CA (US); Sigen YE, San Diego, CA (US); Wei ZENG, Saratoga, CA (US); Weidong YANG, San Diego, CA (US); Yushu ZHANG, Beijing (CN)

(21) Appl. No.: 18/857,290

(22) PCT Filed: Apr. 24, 2022
(86) PCT No.: PCT/CN2022/088748

§ 371 Date: Oct. 16, 2024

(51) Int. Cl. H04W 52/02; H04L 5/00; H04W 72/12

(52) U.S. Cl. CPC H04W 52/0206; H04L 5/001; H04L 5/0051; H04W 72/12

(57) ABSTRACT

A base station operates at least a first cell that deploys a first component carrier (CC) and a second cell that deploys a second CC. The base station is configured to activate a power saving mode of operation at the second cell of the base station, wherein the power saving mode of operation includes deactivating a continuous data exchange processing functionality for the second CC of the second cell and receive, when the power saving mode of operation is activated, a wake up signal (WUS) from a user equipment (UE) configured to trigger the base station to utilize an active mode of data exchange processing to communicate with the UE on the second CC of the second cell.

### TECHNICAL FIELD

The present disclosure generally relates to communication, and in particular, to the network power saving mode.

### BACKGROUND

A user equipment (UE) may connect to a network via a base station. Typically, energy saving techniques that are implemented on the network side and/or the UE side are designed to conserve power at the UE. However, energy consumption is also a concern on the network side and there is a need for energy saving techniques designed to mitigate network energy consumption.

### SUMMARY

Some exemplary embodiments are related to one or more processors of a base station, wherein the base station operates at least a first cell that deploys a first component carrier (CC) and a second cell that deploys a second CC. The one or more processors are configured to perform operations including activating a power saving mode of operation at the second cell of the base station, wherein the power saving mode of operation includes deactivating a continuous data exchange processing functionality for the second CC of the second cell and receiving, when the power saving mode of operation is activated, a wake up signal (WUS) from a user equipment (UE) configured to trigger the base station to utilize an active mode of data exchange processing to communicate with the UE on the second CC of the second cell.

Other exemplary embodiments are related to a base station having one or more transceivers configured to communicate with a user equipment (UE), wherein the base station operates at least a first cell that deploys a first component carrier (CC) and a second cell that deploys a second CC. The base station also has one or more processors that are communicatively coupled to the one or more transceivers. The one or more processors are configured to perform operations including activating a power saving mode of operation at the second cell of the base station, wherein the power saving mode of operation includes deactivating a continuous data exchange processing functionality for the second CC of the second cell and receiving, when the power saving mode of operation is activated, a wake up signal (WUS) from a user equipment (UE) configured to trigger the base station to utilize an active mode of data exchange processing to communicate with the UE on the second CC of the second cell.

Still further exemplary embodiments are related to a processor of a user equipment (UE) configured to perform operations. The operations include receiving configuration information for a power saving mode of operations to be utilized by a base station at a first serving cell of the UE, wherein the power saving mode includes deactivating a continuous data exchange processing functionality a first component carrier (CC) deployed by the serving cell and transmitting, when the power saving mode is activated at the first serving cell, a wake up signal to the base station, wherein the wake up signal is configured to trigger the base station to utilize an active mode of data exchange processing to communicate with the UE on the first CC deployed by the serving cell.

Additional exemplary embodiments are related to a user equipment (UE) having a transceiver configured to communicate with a base station and a processor communicatively coupled to the transceiver and configured to perform operations. The operations include receiving configuration information for a power saving mode of operations to be utilized by a base station at a first serving cell of the UE, wherein the power saving mode includes deactivating a continuous data exchange processing functionality a first component carrier (CC) deployed by the serving cell and transmitting, when the power saving mode is activated at the first serving cell, a wake up signal to the base station, wherein the wake up signal is configured to trigger the base station to utilize an active mode of data exchange processing to communicate with the UE on the first CC deployed by the serving cell.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows examples of deployment scenarios for implementing a network power saving mode of operation according to various exemplary embodiments.

FIG. 5 shows examples of network power saving mode (PSM) cycles according to various exemplary embodiments.

FIG. 6 shows an example of a system information block (SIB) broadcast on cell that is not a PSM enabled serving cell that corresponds to discovery reference signal (DRS) transmitted by a PSM enabled cell according to various exemplary embodiments.

FIG. 7 shows examples for scheduling request (SR)-wake up signal (WUS) configuration for multiple serving cells according to various exemplary embodiments.

FIG. 8 shows an example configured grant (CG)-physical uplink shared channel (PUSCH)-WUS for PSM operation according to various exemplary embodiments.

FIG. 9 shows examples of physical random access channel (PRACH)-WUS based PSM operation according to various exemplary embodiments.

FIG. 10 shows an example payload of downlink control information (DCI) format 2_X according to various exemplary embodiments.

### DETAILED DESCRIPTION

The exemplary embodiments may be further understood with reference to the following description and the related appended drawings, wherein like elements are provided with the same reference numerals. The exemplary embodiments introduce various exemplary techniques for implementing a network power saving mode directed towards minimizing network energy consumption. Throughout this description, the network power saving mode may be referred to as “PSM.” However, reference to PSM is merely provided for illustrative purposes, different entities may refer to a similar concept by a different name.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with regard to a fifth generation (5G) New Radio (NR) network and a next generation node B (gNB). However, reference to a 5G NR network and a gNB is merely provided for illustrative purposes. The exemplary embodiments may be utilized with any appropriate type of network and base station.

PSM may include utilizing a power saving or sleep mode of inactivity to conserve power at the base station (e.g., gNB). Throughout this description, the term “PSM cycle” may be used to refer to a duration of time during which the gNB may be configured with zero or more time intervals where an active mode of data exchange processing is to be utilized. The active mode of data exchange processing may refer to the gNB performing operations that enable the gNB to exchange signals with one or more UEs. For example, the gNB may be configured with a scheduled or triggered time interval during which the gNB is to utilize the active mode of data exchange processing to monitor for and process uplink traffic. In one example, a scheduled time interval during which the gNB is to utilize the active mode of data exchange processing may be to receive a wake-up signal (WUS) or any other appropriate type of signal indicating that information and/or data is scheduled for the gNB. In another example, a scheduled time interval during which the gNB is to utilize the active mode of data exchange processing may be to transmit a PSM indicator (PSMI) to one or more UEs. However, these examples are merely provided for illustrative purposes. According to some aspects, the exemplary embodiments relate to reducing the active mode of data processing related to operating a carrier of a serving cell.

Outside of time intervals during which the gNB is to utilize the active mode of data exchange processing, the gNB may have an opportunity to utilize the power saving or sleep mode of inactivity and conserve power. Reference to the power mode or sleep mode of inactivity does not necessarily mean putting processing components, transmitting components and receiving components of a serving cell operated by the gNB to sleep, in hibernation, or in deactivation. Instead, the power saving or sleep mode of inactivity described herein relates to conserving power by discontinuing at least a subset of continuous data exchange processing functionality associated with operating as a serving cell for one or more UEs.

The gNB may operate multiple cells that each deploy one or more carriers. Throughout this description, to differentiate between carriers controlled by the same gNB, reference is made to different numbered component carriers (e. g., CC #1, CC #2, CC #3, etc.). CC #1 may be used to identify a carrier operated in a legacy manner and thus, CC #1 is not PSM enabled. The other numbered CCs (e.g., CC #2, CC #3, etc.) are intended to identify PSM enabled carriers. In some examples, a single UE may be configured with multiple CCs (e.g., CC #1, CC #2, CC #3, etc.) in a carrier aggregation (CA) or dual-connectivity (DC) configuration. In other examples, a single UE may interact with only one of the PSM enabled cells. Therefore, reference to a CC throughout this description does not necessarily mean that CA and/or DC is currently configured by the gNB for one of its UEs. Instead, the numbered CCs are intended to differentiate the different carriers deployed by cells controlled by a same gNB.

According to some aspects, the exemplary embodiments introduce techniques related to signaling PSM configuration information and/or reference signals associated with PSM. In another aspect, the exemplary embodiments include techniques for implementing a WUS for PSM. These exemplary techniques may be used to reduce power consumption on the network side without increasing power consumption, increasing latency or causing performance degradation for UEs. Each of the exemplary techniques described herein may be used independently from one another, in conjunction with currently implemented network power saving mechanisms, in conjunction with future implementations of network power saving mechanisms or independently from other network power saving mechanisms.

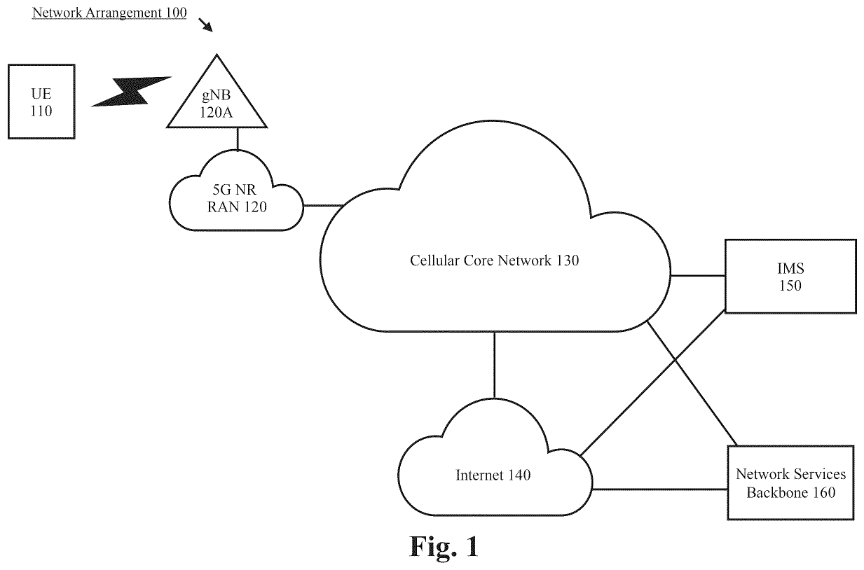

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

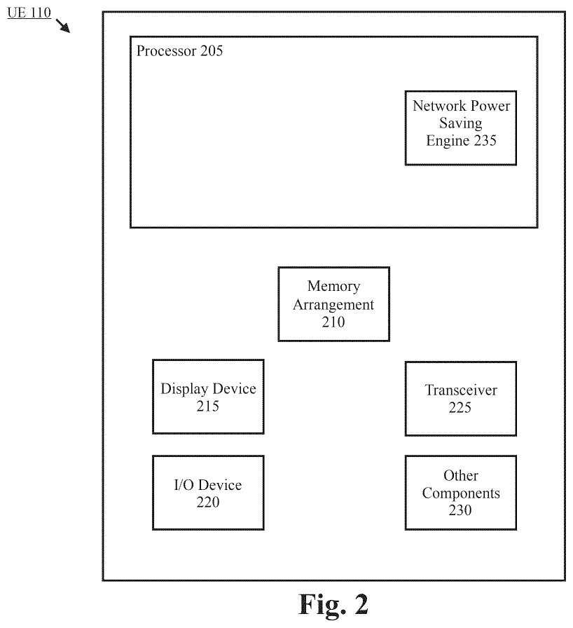

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a network power saving engine 235. The network power saving engine 235 may perform various operations related network power saving such as, but not limited to, receiving PSM configuration information, receiving reference signals and transmitting a WUS.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

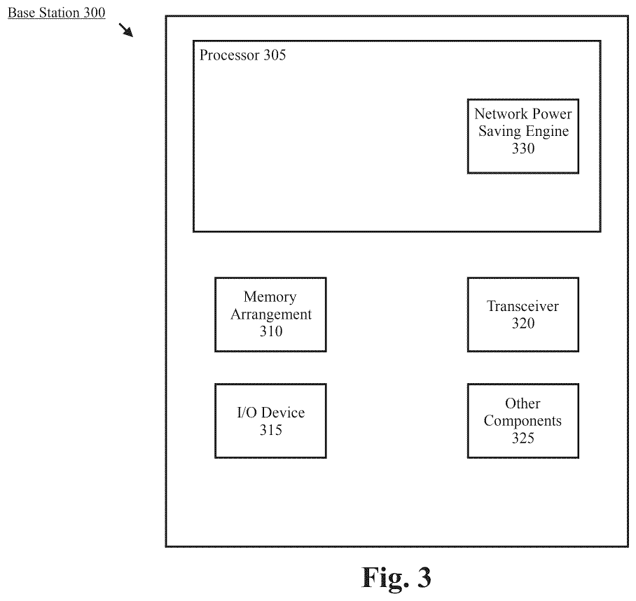

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320 and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the base station 300. For example, the network power saving engine 330 may perform various operations related network power saving such as, but not limited to, transmitting PSM configuration information, transmitting reference signals, configuring a PSM cycle and receiving a WUS.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

According to certain exemplary aspects, for PSM operation, two or more cells may deploy carriers with overlapping coverage areas. As mentioned above, to differentiate between different carriers, reference is made to different numbered CCs (e.g., CC #1, CC #2, CC #3, etc.). CC #1 may be operated in a legacy manner and thus, CC #1 is not PSM enabled. This may ensure backwards compatibility for legacy UEs (e.g., Rel-15, Rel-16, Rel-17, etc.). In some embodiments, CC #1 may be deployed on frequency range 1 (FR1).

It may be assumed that the other numbered CCs (e. g., CC #2, CC #3, etc.) support the exemplary PSM described herein. In some embodiments, the absolute radio frequency channel number (ARFCN) of CC #2 may not be located in a global synchronization channel number (GSCN) for the corresponding frequency band (e.g., frequency range 2 (FR2)) to avoid legacy UEs accessing CC #2 through an initial access procedure during cell selection. However, CC #1 and CC #2 are not required to be deployed on FR1 and FR2 respectively and may be deployed in any appropriate arrangement.

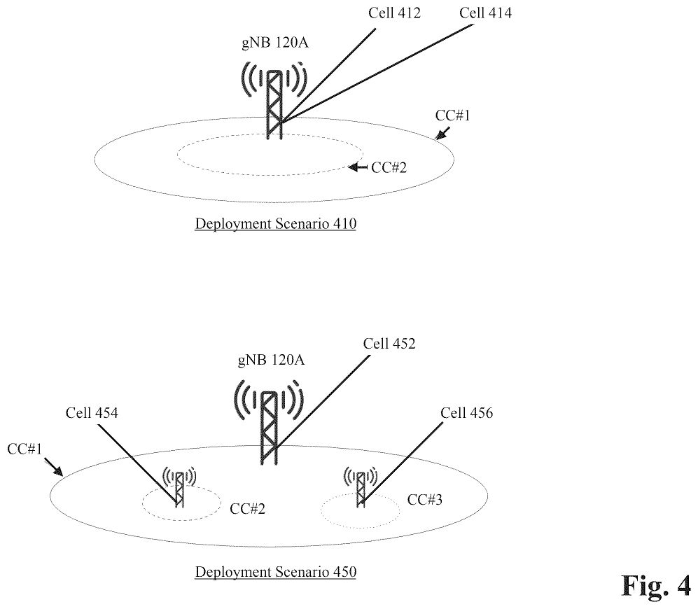

FIG. 4 shows examples of deployment scenarios for implementing a network power saving mode of operation according to various exemplary embodiments. In deployment scenario 410, the gNB 120A operates a first cell 412 that deploys CC #1 and a second co-located cell 414 that deploys CC #2. In this example, CC #1 has a larger coverage area to ensure that the gNB 120A provides sufficient coverage (e.g., FR1) and CC #2 may be used to improve throughput (e.g., FR2).

In deployment scenario 450, the gNB 120A operates a first cell 452 that deploys CC #1, a second cell 454 that deploys CC #2 and a third cell 456 that deploys CC #3. Cell 454 and cell 456 are not co-located with cell 452 but have coverage areas that overlap with CC #1. In this example, CC #2 and CC #3 are both PSM enabled and may have similar characteristics. The deployment scenarios 410 and 450 are provided for illustrative purposes and are not intended to limit the exemplary embodiments in any way. The exemplary embodiments may apply to deployment scenarios involving any appropriate number of carriers or CCs deployed that are each deployed on either FR1 or FR2.

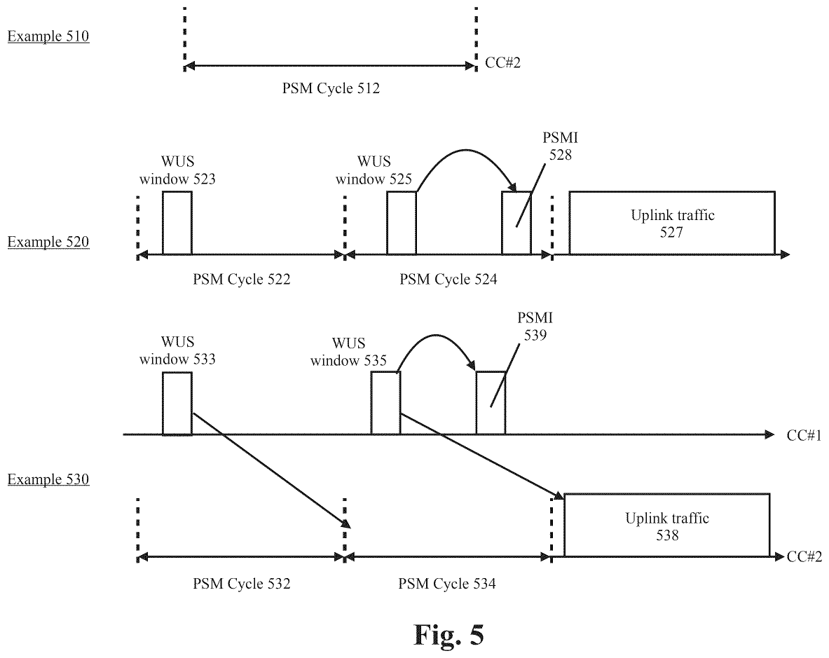

FIG. 5 shows examples of PSM cycles according to various exemplary embodiments. These examples are described with regard to the deployment scenarios 410 and 450 of the FIG. 4. Throughout this description, a PSM cycle refers to a defined duration of time (Z) during which the gNB may be configured with zero or more time intervals where an active mode of data exchange processing is to be utilized to exchange data a carrier deployed by a cell of the gNB. Within the PSM cycle duration (Z) and outside of the zero or more time intervals, the gNB may utilize a power saving mode or sleep mode of inactivity where the gNB may discontinue at least a subset of data exchange processing operations typically performed to exchange signals on the carrier deployed by the cell of the base station.

In some embodiments, multiple different types of PSM cycles may be supported. For example, a first type of PSM cycle may be configured with a first cycle duration and a second type of PSM cycle may be configured with a second different cycle duration. Throughout this description, to differentiate between different types of PSM cycles, reference is made to a short PSM cycle and a long PSM cycle where the short PSM cycle has a shorter defined duration than the long PSM cycle. However, reference to a short and long PSM cycle is merely provided for illustrative purposes, the exemplary embodiments may support any appropriate number of different types of PSM cycles.

Example 510 shows a PSM cycle 512 on CC #2 with zero time intervals where the gNB is configured in an active mode of data exchange processing for CC #2. Thus, during the entirety of the PSM cycle 512, the gNB 120A has the opportunity to utilize a power saving mode of inactivity and conserve power.

Example 520 shows CC #2 and two consecutive PSM cycles 522-524. PSM cycle 522 is configured with WUS window 523 and PSM cycle 524 is configured with WUS window 525. During a WUS window, the gNB 120A may be configured to use an active mode of data exchange processing to monitor for signals transmitted by one or more UEs. When a WUS is not received during a WUS window, the gNB 120A may use a power saving mode of inactivity during a subsequent PSM cycle on the PSM enabled CC. In example 520, a WUS is not received during the WUS window 523 and thus, the gNB 120A may power-off the corresponding CC in the associated PSM cycle 522 to save power. When a WUS is received during the WUS window, the gNB 120A may power-on the corresponding CC in a same or subsequent PSM cycle. In example 520, a WUS is received during the WUS window 525. Therefore, subsequent to the PSM cycle 524, the gNB 120A activates CC #2 and uses an active mode of data exchange processing to monitor for and process uplink traffic 527.

The reception of a WUS may trigger the gNB 120A to transmit a PSM indicator (PSMI) signal to one or more UEs. The PSMI may be configured to inform one or more UEs that the CC of the serving cell is to be activated. In example 520, the transmission of the PSMI 528 is triggered based on the reception of the WUS during the WUS window 525. However, in some embodiments, PSMI transmission may be independent from the reception of the associated WUS. For example, the gNB 120A may be triggered to power-on a CC of a serving cell and use the active mode of data exchange processing due to downlink traffic demand at the gNB 120A. This may occur with or without receiving a corresponding WUS from UEs within the associated WUS window. Additional details regarding the contents and use of PSMI are provided below.

Example 530 shows CC #1 and CC #2. CC #2 is configured with two consecutive PSM cycles 532-536 and CC #1 is configured with their corresponding WUS windows 533-535. As mentioned above, CC #1 is not PSM enabled. However, the gNB 120A may transmit signals on CC #1 that correspond to the PSM cycle configured on CC #2. This approach allows the power saving or sleep mode of inactivity to occur over the entire duration of a PSM cycle on CC #2. In example 530, a WUS is not received during WUS window 533 and thus, the gNB 120A is able to utilize the power saving mode of inactivity during the entirety of PSM cycle 534 on CC #2. A WUS may be received during WUS window 535 and thus, the gNB 120A is scheduled to monitor for and process uplink traffic 538 on CC #2 subsequent to the PSM cycle 534. In this example, the WUS received during the WUS window 535 may trigger the transmission of PSMI 539 on CC #1 to indicate that the gNB 120A is to power-on CC #2 as shown in FIG. 5.

The gNB 120A may provide PSM configuration information to one or more UEs. Throughout this description, the term “PSM configuration information” may generally refer to information transmitted by a gNB comprising parameters and/or configurations corresponding to a network power saving mode of operation that may be utilized at the gNB to minimize network energy consumption. Specific examples of PSM configuration information such as, but not limited to, PSM cycle and offset parameters, reference signal configuration information, WUS configuration information and a WUS window duration are described below. However, any reference to a certain parameter or type of information being characterized as “PSM configuration information” is provided as a non-limiting example, the exemplary signaling techniques described herein may be used to convey any appropriate type of information related to PSM.

The PSM configuration information for a cell may indicate that the gNB 120A is to utilize a power saving mode of operation for the cell deployed by the gNB 120A. The PSM configuration information may include PSM cycle and offset parameters. In some embodiments, there may be different types of PSM cycles (e.g., short, long, etc.) and thus, the PSM configuration information may include parameters associated with one or more different PSM cycles. In addition, the PSM configuration information may include configuration information for reference signals that may be provided by a serving cell for PSM (e.g., discovery reference signals (DRS), etc.). These parameters may include, but are not limited to, one or more sets of reference signals, reference signal periodicity and/or offset and quasi co-location (QCL) information. In addition, the PSM configuration information may include WUS configuration information comprising parameters such as, but not limited to, a type of WUS signal, trigger conditions, a WUS configuration for UEs in RRC idle mode, a WUS configuration for UEs in RRC inactivate mode, and a WUS window duration.

The PSM configuration information may be provided to UEs in a system information block (SIB). In some embodiments, SIB1 is utilized to provide PSM configuration information to one or more UEs. In other embodiments, a new SIB may be introduced for, at least in part, providing PSM configuration information to one or more UEs. To provide an example within the context of the network arrangement 100, the UE 110 may perform a cell search by tuning its transceiver 225 to various frequencies to monitor for available cells. A cell of the gNB 120A may broadcast a SIB comprising PSM configuration information. Alternatively, or in addition to the SIB, PSM configuration information may be provided in a medium access control (MAC) control element (CE), downlink control information (DCI), a radio resource control (RRC) signal, an uplink grant, any other appropriate type of downlink signal or any combination thereof. Once connected, the UE 110 may know the type of behavior to expect from the gNB 120A with regard to PSM based on the PSM configuration information.

According to some exemplary aspects, a discovery reference signal (DRS) is introduced that may be broadcasted by a PSM enabled serving cell. As will be described in more detail below, a variety of different approaches may be used to transmit a periodic DRS on a PSM enabled serving cell. The DRS may allow the UE 110 to perform operations such as, but not limited to, cell identification, automatic gain control (AGC) settling and fine time and frequency tracking for downlink reception.

The periodicity and slot offset for each PSM enabled serving cell may be provided as PSM configuration information in a SIB. In some embodiments, SIB1 of a PSM enabled serving cell may be transmitted on a different serving cell that is not enabled with PSM operation to minimize the duration of time in which the active mode of data exchange processing is utilized by the PSM enabled serving cell. For example, CC #1 may broadcast an SIB (e.g., SIB1 or any other type of SIB configured to convey PSM configuration for other CCs) providing PSM configuration information corresponding to CC #2. This approach may mitigate the restriction of 20 millisecond (ms) SSB periodicity by using DRS with a configurable periodicity and therefore, reduce the power consumption for low-load or idle serving cells.

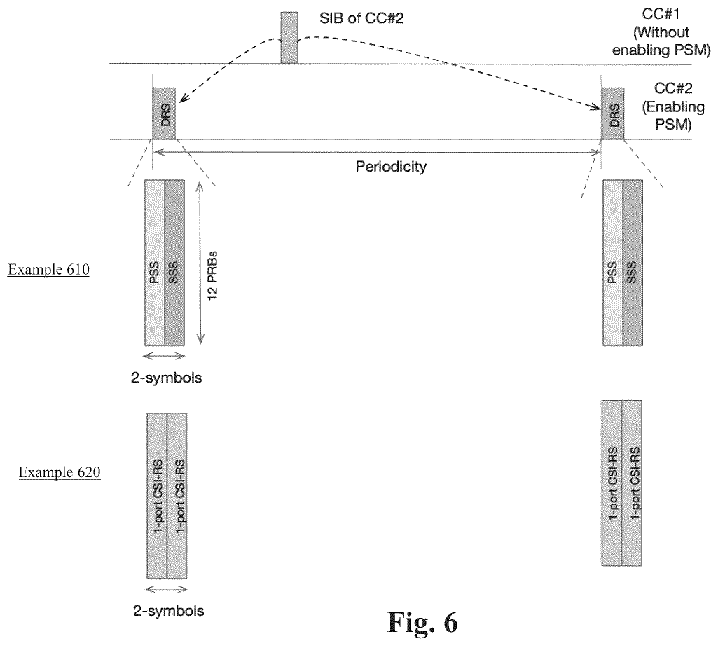

FIG. 6 shows an example of a SIB broadcasted on cell (e.g., CC #1) that is not a PSM enabled serving cell that is used to indicate configuration of DRS transmitted by a PSM enabled cell (e.g., CC #2). In example 610, a DRS may consist of two consecutive symbols in the time domain. A primary synchronization signal (PSS) may occupy a first symbol of the DRS and a secondary synchronization signal (SSS) may occupy a second symbol of the DRS. In this example, the DRS may span 12 physical resource blocks (PRBs) per symbol. In example 620, the DRS may comprise two-symbol one-port channel state information (CSI)-reference signal (RS). In one example, the DRS may be configured with QCL type D with SSB or a tracking reference signal (TRS) from another serving cell that is not PSM enabled. For example, the DRS on CC #2 may be QCL type D with an SSB or TRS on CC #1. In further embodiments, an SSB may be used as DRS for a PSM enabled serving cell with a configurable periodicity (e.g., larger than 20 ms).

In the examples provided above, it may be assumed that the subframe number (SFN) timing of the PSM enabled serving cell (e.g., CC #2) and the other serving cell where PSM is not enabled (e.g., CC #1) are aligned. In addition, the slots may be aligned. Alternatively, a slot offset in units of a reference slot between a first CC and a second CC may be configured using SIB information. The subcarrier spacing (SCS) of the reference slot may be configured or hard encoded in 3GPP Specifications based on the frequency range (FR), e.g., largest SCS for each of FR1 and FR2.

According to some aspects, the exemplary embodiments introduce a WUS that may be transmitted by a UE for a PSM enabled serving cell on the PSM enabled serving cell or on another serving cell that is not PSM enabled. As will be described in more detail below, a variety of signals and channels may be configured as the exemplary WUS described herein. In one approach, a scheduling request (SR) may be used as the WUS signal for a PSM operation. Throughout this description, a SR configured as a WUS may referred to as a “SR-WUS.” It may be beneficial to limit the use of SR-WUS to RRC connected UEs due to the lack of accurate uplink timing of RRC idle and RRC inactive UEs. However, this limitation is not required and the exemplary SR-WUS may be used by UEs in any RRC state.

The configuration information for the SR-WUS may be provided to the UE 110 in an RRC message or any other appropriate type of signal. For example, the gNB 120A may use dedicated RRC signaling to configure the UE 110 with the channel and timing information for SR-WUS opportunities. The SR-WUS configuration information may include a PUCCH format and corresponding PUCCH resources for SR-WUS transmission. In some embodiments, the PUCCH format may be PUCCH format 0 or PUCCH format 1 and carry one bit SR-WUS. In addition, the SR-WUS configuration information may include a periodicity and slot offset. In some embodiments, the periodicity of the SR-WUS is the same as the periodicity of the PSM cycles where one SR-WUS occasion is provided for each PSM cycle. The slot offset for the SR-WUS may be configured relative to a starting symbol of a short PSM cycle. The slot offset may be measured in slots, symbols or any other appropriate time parameter.

Different options may be considered for the association between SR-WUS resources and PSM enabled serving cells. In one approach, each SR-WUS resource in a set of SR-WUS resources is mapped to a different serving cell. In another approach, one SR-WUS resource may be assigned to a single UE and applied for all serving cells that are PSM enabled. The preferred serving cell indices for the subsequent data communication may be provided in other subsequent signals as part of UE assistance information.

In either of the above approaches, a subsequent PUSCH transmission may be scheduled via an uplink grant. The UE 110 may transmit UE assistance information for PSM operation to the qNB 120A in the PUSCH transmission. The UE assistance information for PSM operation may be configured to assist CC power-on operation at the network side. In some embodiments, a preferred CC index or set of CC indices may be reported by the UE 110. A preferred CC may be determined based on reference signal receive power (RSRP) or any other appropriate one or more parameters. If more than one CC is reported by the UE 110, the CCs selected by the network for the UE 110 may be indicated by a PSMI. In other embodiments, the UE 110 may provide measurement data such as, but not limited to, CSI-RS indication (CRI)-RSRP, SSB-Index-RSRP and/or a DRS-RSRP. The network may configure the UE 110 with an RSRP threshold and the UE 110 may be triggered to report values that exceed the threshold value. It may be beneficial to utilize this type of reporting for FR2 where multiple downlink beams are deployed for each PSM enabled CC.

In further embodiments, the UE 110 may provide a buffer status report (BSR) in the PUSCH transmission. In some embodiments, the UE 110 may provide a 5G quality of service (QoS) identifier mapped to one of the standardized 5QI values which refers to a row of a predefined table that includes a set of parameters such as, but not limited to, resource type (e.g., guaranteed bit rate (GBR), non-GBR, etc.), default priority level, packet delay budget, packet error rate, default maximum data burst volume and default average window. In other embodiments, the UE 110 may request aperiodic SSB or aperiodic TRS for fine time/frequency tracking on the preferred CCs. Different configurations (e.g., one burst, two burst, etc.) of an aperiodic SSB or an aperiodic TRS may be supported and a preferred configuration may be provided by the UE 110 based on the measurement cycle configuration information on the preferred CCs.

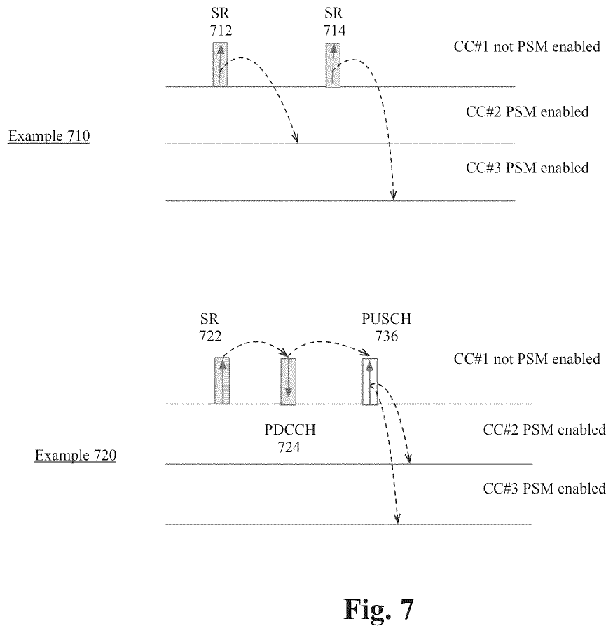

FIG. 7 shows examples for SR-WUS configuration for multiple serving cells according to various exemplary embodiments. Example 710 shows CC #1 which is not PSM enabled, CC #2 which is PSM enabled and CC #3 which is PSM enabled. Two SR resources 712 and 714 may be configured for the UE 110 using RRC signaling. The SR resource 712 on CC #1 may be configured for the UE 110 as an SR-WUS for CC #2. The SR resource 714 on CC #1 may be configured for the UE 110 as an SR-WUS for CC #3. Thus, the UE 110 may transmit a SR on a serving cell that is not PSM enabled to trigger the gNB 120A to power-on another CC of another serving cell that is PSM enabled.

Example 720 shows CC #1 which is not PSM enabled, CC #2 which is PSM enabled and CC #3 which is PSM enabled. The SR resource 722 may be configured for the UE 110 on CC #1 of a serving cell that is not PSM enabled. The UE 110 may then monitor for a subsequent physical downlink control channel (PDCCH) 724 on CC #1 comprising an uplink grant for scheduling PUSCH on CC #1. The UE 110 may then transmit UE assistance information for PSM operation in a PUSCH transmission 736 on CC #1. The information provided by the UE 110 in the PUSCH 736 may enable the network to decide which CC or CCs the gNB 120A is to power-on for subsequent communication. In example 720, a single SR resource 722 may be utilized by the UE 110 as a SR-WUS for multiple CCs. This configuration of SR resources, PDCCH and PUSCH may also be applicable to examples in which a single SR resource is configured as a SR-WUS for a single CC, e.g., example 710.

In another approach, the UE 110 may be semi-statically configured with a configured grant (CG) PUSCH as a WUS for one or more CCs. Throughout this description, a CG PUSCH configured as a WUS may be referred to as a “CG-PUSCH-WUS.” The parameters to be applied to a CG-PUSCH-WUS transmission may be provided by higher layer signaling. These parameters may include, but are not limited to, modulation and coding scheme (MCS), time domain resource allocation, frequency domain resource allocation, periodicity, transmission waveform and antenna ports.

In some embodiments, the CG-PUSCH-WUS resources may be shared with other UL-SCH transmissions. To differentiate between UL-SCH transmissions, a one bit identification may be introduced in the CG-PUSCH-WUS to indicate the CG-PUSCH type. If a MAC CE or MAC protocol data unit (PDU) is utilized for the CG-PUSCH-WUS, the identification IE may be replaced by a MAC CE header with a dedicated logical channel ID (LCID).

In some embodiments, the UE assistance information for PSM operation described above may be included as part of the CG-PUSCH-WUS payload. In other embodiments, the CG-PUSCH-WUS may be shared by more than one UE. To differentiate between UEs, a UE ID such as a cell-radio network temporary identifier (C-RNTI) may be included in the CG-PUSCH-WUS payload. In this example, the initialization ID for CG-PUSCH-WUS scrambling by the UE is either configured by higher layer signaling or the cell ID of the serving cell that is to receive the CG-PUSCH-WUS may be utilized.

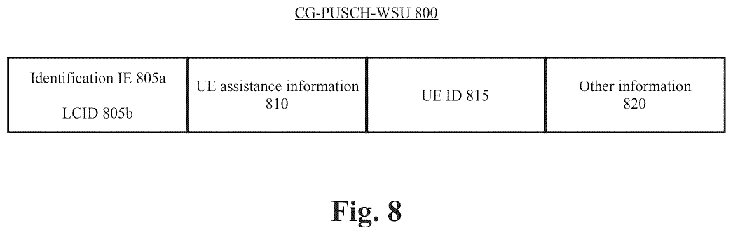

FIG. 8 shows an example CG-PUSCH-WUS 800 for PSM operation according to various exemplary embodiments. The CG-PUSCH-WUS may include an identification IE 805a or alternatively, a LCID 805b may be used to indicate the CG-PUSCH-WSU if a MAC CE or MAC PDU is utilized for the CG-PUSCH-WUS. In addition, the CG-PUSCH-WUS 800 may include UE assistance information 810, a UE ID 815 (e.g., C-RNTI, etc.) and other information 820. The other information 820 may include information such as, but not limited to, an uplink shared channel (UL-SCH) payload and a cyclic redundancy check (CRC) field. The UL-SCH payload may be used for transmitting uplink data from the UE 110 to the gNB 120A.

In another approach, the UE 110 may be provided with a physical random access channel (PRACH) resource that may be used as a WUS for PSM operation. Throughout this description, a PRACH resource configured as a WUS may referred to as a “PRACH-WUS.”

In some embodiments, a dedicated PRACH resource may be used as a PRACH-WUS that is configured with an association to periodic DRS on a CC of a PSM enabled cell to trigger power-on of that CC. In other embodiments, a set of PRACH resources may be provided in a SIB message and used as PRACH-WUS. The association between PRACH-WUS resources and (N) beamformed DRS may be configured by the SIB. The UE 110 may then select a PRACH-WUS to indicate the preferred DRS on a given CC. This may allow a PRACH resource to be transmitted on a CC that is PSM enabled or on a CC that is not PSM enabled to minimize the amount of active data processing performed by the PSM enabled serving cell.

In addition, the UE 110 may provide UE assistance information for PSM operation in message 3 (msg3) if type-1 random access procedure is applied or in message A (msgA) if PUSCH type-2 random access procedure is applied for PSM operation.

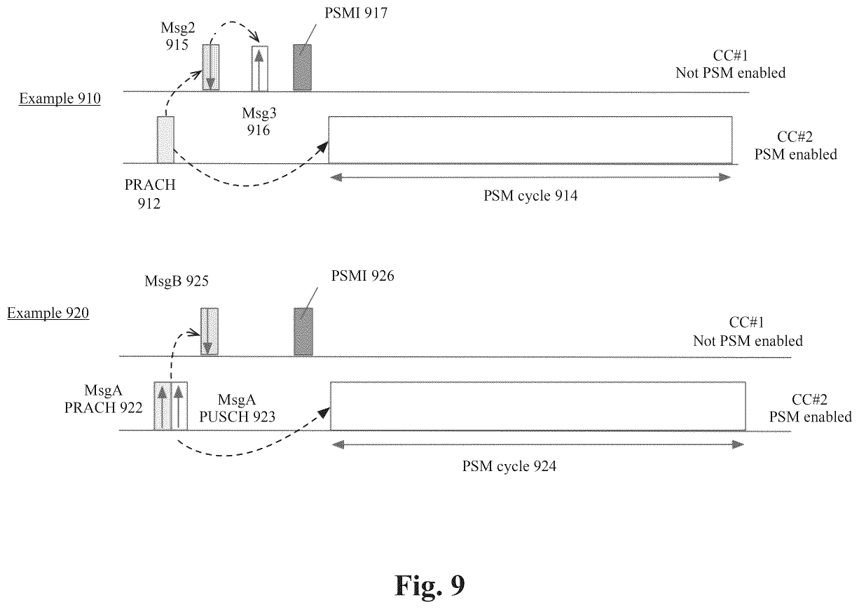

FIG. 9 shows examples of PRACH-WUS based PSM operation according to various exemplary embodiments. Example 910 shows CC #1 which is not PSM enabled and CC #2 which is PSM enabled. The UE 110 may transmit a PRACH-WUS on PRACH resource 912 of CC #2. This may trigger power-on operation of CC #2 for the associated PSM cycle 914. In this example, the subsequent message 2 (msg2) 915 (e.g., random access response (RAR)) may be provided by the qNB 120A on CC #1. The UE 110 may then transmit msg3 916 on CC #1 comprising UE assistance information for PSM on CC #2. In addition, PSMI 917 may be transmitted to the UE 110 on CC #1 for confirmation that uplink and/or downlink signals may be exchanged with the PSM enabled serving cell on CC #2 for the associated PSM cycle 914.

Example 920 shows CC #1 which is not PSM enabled and CC #2 which is PSM enabled. The UE 110 may transmit a PRACH-WUS on PRACH resource of CC #2. In this example, msgA PRACH 922 and msgA PUSCH 923 may be provided to the gNB 120A on CC #2. The msgA PRACH 922 may trigger power-on for the associated PSM cycle 924 and the msgA PUSCH 923 may be used to provide UE assistance information for PSM operation on CC #2. In response, the UE 110 may receive the message B (msgB) 925 (e.g., RAR) on CC #1. In addition, PSMI 926 may be transmitted to the UE 110 on CC #1 for confirmation that uplink and/or downlink signals may be exchanged with the PSM enabled serving cell on CC #2 for the associated PSM cycle 924.

As indicated above, according to some aspects, the exemplary embodiments introduce a PSMI that may be transmitted by a cell of a gNB 120A to indicate that the gNB 120A is to power-on a CC to enable a subsequent data exchange on that CC for a corresponding PSM cycle. In some embodiments a group common DCI format 2_X may be introduced as a PSMI. The notation 2_X is being used herein to refer to DCI format that has the characteristics as described below that has yet to be identified by a number and/or letter. The exemplary embodiments are described as providing various manners of signaling a DCI having the characteristics of the exemplary DCI 2_X. However, it should be understood that the exemplary embodiments may be applicable to any DCI currently defined and/or future implementations, e.g., DCI_X.

The following information may be provided in the DCI format 2_X with CRC scrambled with an RNTI (e. g., PSM-RNTI, etc.). The DCI format 2_X may be comprised of (M) PSMI blocks (PSMIBs), e.g., PSMIB #1, PSMIB #2, PSMIB #M, etc. For each PSM enabled serving cell, a UE may be provided a location of a PSMIB. The size of the DCI format 2_X may be configurable by SIB, RRC signaling, hard encoded in 3GPP Specifications or provided in any other appropriate manner.

The following subfields may be defined for each PSMIB. A PSMIB may indicate a PSM state using one bit where a first value indicates a power-on state for an associated PSM enabled serving cell and a second value indicates a power saving state for the associated PSM enabled serving cell. The PSMIB may also indicate a number of PSM cycles for which the corresponding PSM state is applicable. For example, a number of PSM cycles parameter may be configured in a SIB or RRC signaling. The DCI format 2_X may include one of the preconfigured values to indicate a number of PSM cycles for the corresponding PSM state of the PSMIB.

In addition, subfields for triggering aperiodic SSB and/or aperiodic TRS may also be included in the PSMIB. For example, a triggering offset of aperiodic SSB or aperiodic TRS relative to the ending symbol of the DCI format 2_X may be provided by the PSMIB. The number of aperiodic SSB or aperiodic TRS bursts may also be indicated in the PSMIB. In addition, a gap value between two consecutive bursts may be provided in scenarios where more than one burst is triggered. Further, a QCL source for the aperiodic SSB or aperiodic TRS on a CC that is no PSM enabled (e.g., CC #1) may the PSMIB.

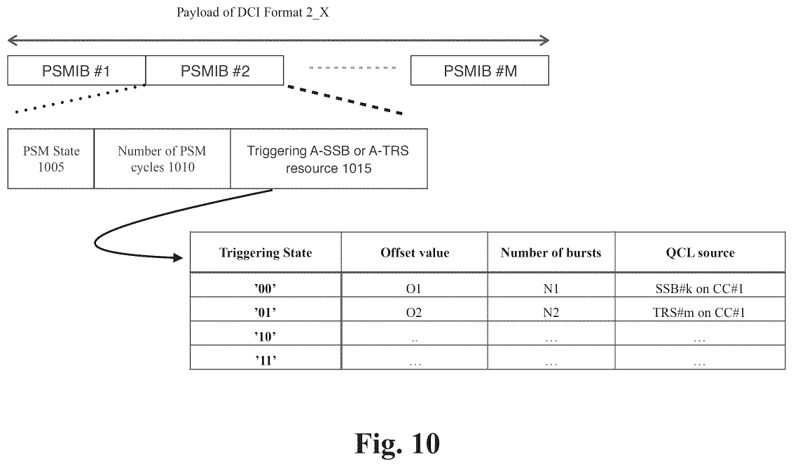

FIG. 10 shows an example payload of DCI format 2_X according to various exemplary embodiments. In this example, the DCI format 2_X include (M) PSMIBs. Each PSMIB may include a PSM state 1005, a number of PSM cycles 1010 and a triggering aperiodic SSB or aperiodic TRS resources 1015. In FIG. 10, only the contents of PSMIB #2 are shown. However, it should be understood that each of the PMIBs may be configured with the same or similar parameters.

The triggering aperiodic SSB or aperiodic TRS resources 1015 may be provided using a triggering state index value. This value may be mapped to a predefined table 1050 that further indicates an offset value, a number of bursts and a QCL source. In this example, the table 1050 includes four triggering states (e.g., 00, 01, 10, 11). However, in an actual deployment scenario any appropriate number of triggering states may be configured. This predefined table may be configured by a SIB, RRC signaling or hard encoded in 3GPP specification.

### EXAMPLES

In a first example, one or more processors of a base station, wherein the base station operates at least a first cell that deploys a first component carrier (CC) and a second cell that deploys a second CC, the one or more processors are configured to perform operations comprising activating a power saving mode of operation at the second cell of the base station, wherein the power saving mode of operation includes deactivating a continuous data exchange processing functionality for the second CC of the second cell and receiving, when the power saving mode of operation is activated, a wake up signal (WUS) from a user equipment (UE) configured to trigger the base station to utilize an active mode of data exchange processing to communicate with the UE on the second CC of the second cell.

In a second example, the one or more processors of the first example, the operations further comprising transmitting, when the power saving mode of operation is activated for the second CC, a discovery reference signal (DRS) on the second CC.

In a third example, the one or more processors of the second example, wherein the DRS comprises a first symbol consecutive to a second symbol in a time domain, wherein a primary synchronization signal (PSS) is mapped to the first symbol and a secondary synchronization signal (SSS) is mapped to the second symbol.

In a fourth example, the one or more processors of the second example, wherein the DRS comprises a two symbol one port channel state information (CSI)-reference signal (RS).

In a fifth example, the one or more processors of the second example, wherein the DRS is a synchronization signal block (SSB) with a configurable periodicity and wherein the periodicity is configured at the UE using a system information block (SIB).

In a sixth example, the one or more processors of the second example, the operations further comprising transmitting a SIB comprising DRS configuration information of the second cell.

In a seventh example, the one or more processors of the sixth example, wherein the DRS configuration information comprises at least one of a periodicity and offset and quasi co- location (QCL) information.

In an eighth example, the one or more processors of the sixth example, wherein the SIB is transmitted on the first CC of the first cell.

In a ninth example, the one or more processors of the first example, wherein the power saving mode of operation includes a power saving mode cycle with a predefined time duration, wherein the power saving mode cycle includes a WUS window during which an active mode of data exchange processing is utilized to monitor for WUSs, wherein a length of the WUS window is shorter than the predefined time duration.

In a tenth example, the one or more processors of the ninth example, the operations further comprising transmitting a system information block (SIB) comprising power saving mode configuration information for the power saving mode of operation, wherein the power saving mode configuration information indicates at least one of the length of the WUS window, the predefined time duration of the power saving mode cycle and a subframe or slot where the power saving mode cycle is configured to start.

In an eleventh example, the one or more processors of the first example, the operations further comprising transmitting a system information lock (SIB) to the UE, the SIB comprising configuration information for the WUS, wherein the SIB is transmitted on the first CC of the first cell.

In a twelfth example, the one or more processors of the first example, wherein the WUS is a scheduling request (SR).

In a thirteenth example, the one or more processors of the twelfth example, the operations further comprising transmitting WUS configuration information to the UE in dedicated a radio resource control (RRC) message.

In a fourteenth example, the one or more processors of the thirteenth example, wherein the WUS configuration information comprises at least one of a physical uplink control channel (PUCCH) format, a periodicity and a slot offset.

In a fifteenth example, the one or more processors of the twelfth example, wherein there is a one-to-one mapping between a PUCCH resource on which the SR was transmitted and a corresponding serving cell for the power saving mode of operation.

In a seventeenth example, the one or more processors of the twelfth example, the operations further comprising receiving a physical uplink shared channel (PUSCH) transmission from the UE corresponding to the SR, wherein the PUSCH transmission include UE assistance information for the power saving mode of operation.

In an eighteenth example, the one or more processors of the seventeenth example, wherein the UE assistance information comprises at least one of a preferred component carrier (CC) index, a set of preferred CC indices, a buffer status report (BSR), a fifth generation (5G) quality of service (QoS) identifier, a request for aperiodic synchronization signal block (SSB) and a request for aperiodic tracking reference signal (TRS).

In a nineteenth example, the one or more processors of the first example, wherein the WUS is a configured grant (CG) physical uplink shared channel (PUSCH) transmission.

In a twentieth example, the one or more processors of the nineteenth example, wherein the CG-PUSCH includes a medium access control (MAC) control element (CE) or protocol data unit (PDU) that is configured with a logical channel ID that indicates that the CG-PUSCH is the WUS.

In a twenty first example, the one or more processors of the nineteenth example, wherein the CG-PUSCH includes at least one or more of UE assistance information for the power saving mode of operation, a UE ID and an identification information element (IE).

In a twenty second example, the one or more processors of the first example, wherein the WUS is transmitted on a physical random access channel (PRACH).

In a twenty third example, the one or more processors of the twenty second example, the operations further comprising receiving a message 3 (msg3) comprising UE assistance information for the power saving mode of operation.

In a twenty fourth example, the one or more processors of the twenty second example, the operations further comprising receiving a message A (msgA) comprising UE assistance information for the power saving mode of operation.

In a twenty fifth example, the one or more processors of the first example, the operations further comprising transmitting downlink control information (DCI) comprising a power saving mode indicator signal (PSMI).

In a twenty sixth example, the one or more processors of the twenty fifth example, wherein the PSMI includes multiple PSMI blocks (PSMIB), each PSMIB configured to indicate that a corresponding CC enabled with power saving mode of operation deployed by the base station is active or deactivated for a corresponding power saving mode cycle.

In a twenty seventh example, the one or more processors of the twenty fifth example, wherein the PSMI includes multiple PSMI blocks (PSMIB) and wherein a first PSMIB is configured to trigger an aperiodic synchronization signal block (SSB) or an aperiodic tracking reference signal (TRS) on the second CC.

In a twenty eighth example, the one or more processors of the first example, wherein the first CC is deployed on frequency range 1 (FR1) and the second CC is deployed on frequency range 2 (FR2).

In a twenty ninth example, a base station comprises one or more transceivers configured to communicate with a user equipment (UE) and one or more processors communicatively coupled to the one or more transceivers and configured to perform any of the operations described above from the first through twenty eighth examples.

In a thirtieth example, a processor of a user equipment (UE) is configured to perform operations comprising receiving configuration information for a power saving mode of operations to be utilized by a base station at a first serving cell of the UE, wherein the power saving mode includes deactivating a continuous data exchange processing functionality a first component carrier (CC) deployed by the serving cell and transmitting, when the power saving mode is activated at the first serving cell, a wake up signal to the base station, wherein the wake up signal is configured to trigger the base station to utilize an active mode of data exchange processing to communicate with the UE on the first CC deployed by the serving cell.

In a thirty first example, the processor of the thirtieth example, the operations further comprising receiving, when the power saving mode of operation is activated for a first CC, a discovery reference signal (DRS) on the first CC.

In a thirty second example, the processor of the thirty first example, wherein the DRS comprises a first symbol consecutive to a second symbol in a time domain, wherein a primary synchronization signal (PSS) is mapped to the first symbol and a secondary synchronization signal (SSS) is mapped to the second symbol.

In a thirty third example, the processor of the thirty first example, wherein the DRS comprises a two symbol one port channel state information (CSI)-reference signal (RS).

In a thirty fourth example, the processor of the thirty first example, wherein the DRS is a synchronization signal block (SSB) with a configurable periodicity, wherein the periodicity is configured at the UE using a system information block (SIB).

In a thirty fifth example, the processor of the thirtieth example, wherein the WUS is a scheduling request (SR).

In a thirty sixth example, the processor of the thirty fifth example, the operations further comprising receiving WUS configuration information in a radio resource control (RRC) message.

In a thirty seventh example, the processor of the thirty fifth example, the operations further comprising transmitting a scheduling request (SR) on the second CC of the second cell, wherein the SR is the WUS and is transmitted on resources assigned to the UE and transmitting a physical uplink shared channel (PUSCH) signal corresponding to the SR on the second CC, wherein the PUSCH signal includes UE assistance information.

In a thirty eighth example, a user equipment (UE) comprises a transceiver configured to communicate with a base station and a processor communicatively coupled to the transceiver and configured to perform any of the operations described above from the thirtieth through thirty seventh examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. One or more processors of a base station, wherein the base station operates at least a first cell that deploys a first component carrier (CC) and a second cell that deploys a second CC, the one or more processors configured to perform operations comprising:
activating a power saving mode of operation at the second cell of the base station, wherein the power saving mode of operation includes deactivating a continuous data exchange processing functionality for the second CC of the second cell; and
receiving, when the power saving mode of operation is activated, a wake up signal (WUS) from a user equipment (UE) configured to trigger the base station to utilize an active mode of data exchange processing to communicate with the UE on the second CC of the second cell.

2. The one or more processors of claim 1, wherein the WUS is received on the second CC of the second cell when the power saving mode of operations is activated at the second cell.

3. The one or more processors of claim 1, wherein the WUS is received on the first CC of the first cell when the power saving mode of operation is activated at the second cell.

4. The one or more processors of claim 1, wherein the power saving mode of operation includes a power saving mode cycle with a predefined time duration, wherein the power saving mode cycle includes a WUS window during which an active mode of data exchange processing is utilized to monitor for WUSs, wherein a length of the WUS window is shorter than the predefined time duration.

5. The one or more processors of claim 1, the operations further comprising:
transmitting, when the power saving mode of operation is activated for the second CC, a discovery reference signal (DRS) on the second CC.

6. The one or more processors of claim 1, the operations further comprising:
transmitting a system information lock (SIB) to the UE, the SIB comprising configuration information for the WUS.

7. The one or more processors of claim 1, wherein the WUS is a scheduling request (SR).

8. The one or more processors of claim 1, wherein the base station assigns a set of PUCCH resources on the first CC of the first cell for transmission of WUS scheduling requests, each PUCCH resource from the set of PUCCH resources is mapped to a different cell of the base station that is power saving mode enabled.

9. The one or more processors of claim 1, the operations further comprising:
receiving a scheduling request (SR) on the first CC of the first cell, wherein the SR is the WUS and is transmitted on resources assigned to the UE; and
receiving a physical uplink shared channel (PUSCH) transmission from the UE corresponding to the SR, wherein the PUSCH transmission includes UE assistance information and wherein the base station selects the second cell from a set of UE serving cells for the power saving mode of operation based on the UE assistance information.

10. The one or more processors of claim 1, wherein the WUS is a configured grant (CG) physical uplink shared channel (PUSCH) transmission.

11. The one or more processors of claim 1, wherein the WUS is transmitted on a physical random access channel (PRACH).

12. A processor of a user equipment (UE) configured to perform operations comprising:
receiving configuration information for a power saving mode of operations to be utilized by a base station at a first serving cell of the UE, wherein the power saving mode includes deactivating a continuous data exchange processing functionality a first component carrier (CC) deployed by the serving cell; and
transmitting, when the power saving mode is activated at the first serving cell, a wake up signal to the base station, wherein the wake up signal is configured to trigger the base station to utilize an active mode of data exchange processing to communicate with the UE on the first CC deployed by the serving cell.

13. The processor of claim 12, wherein the WUS is transmitted to the base station on a second CC of a second different serving cell when the power saving mode of operation is activated at the first cell.

14. The processor of claim 12, wherein the WUS is transmitted to the base station on a first CC of the first serving cell when the power saving mode of operation is activated at the first cell.

15. The processor of claim 12, wherein the configuration information is received in a system information block (SIB) and comprises at least one of a power saving mode cycle and offset, configuration information for a discovery reference signal (DRS), a length of a WUS window and configuration information for the WUS.

16. The processor of claim 12, the operations further comprising:
receiving, when the power saving mode of operation is activated for a first CC, a discovery reference signal (DRS) on the first CC.

17. The processor of claim 12, wherein the WUS is a scheduling request (SR).

18. The processor of claim 12, wherein the WUS is a configured grant (CG) physical uplink shared channel (PUSCH) transmission.

19. The processor of claim 12, wherein the WUS is transmitted on a physical random access channel (PRACH).

20. The processor of claim 12, the operations further comprising:
receiving downlink control information (DCI) comprising a power saving mode indicator signal (PSMI) used to indicate that a corresponding first CC enabled with the power saving mode of operation that is deployed by that base station is activated or deactivated for a corresponding power saving mode cycle.
